(19) United States
(12) Patent Application Publication
(10) Pub. No.: US 2014/0055384 A1
(43) Pub. Date: Feb. 27, 2014

(54) TOUCH PANEL AND ASSOCIATED DISPLAY METHOD

(71) Applicant: WISTRON CORPORATION, New Taipei City (TW)

(72) Inventors: Yi-Hsuan Cheng, New Taipei City (TW); Hsih-Bin Dai, New Taipei City (TW); Chen-Yi Liang, New Taipei City (TW)

(73) Assignee: WISTRON CORPORATION, New Taipei City (TW)

(21) Appl. No.: 13/787,909

(22) Filed: Mar. 7, 2013

(30) Foreign Application Priority Data
Aug. 22, 2012 (TW) 101130401

(51) Int. Cl. G06F 3/0488

(52) U.S. Cl. CPC G06F 3/0488
USPC 345/173

(57) ABSTRACT

A display for a display panel is provided. The display method includes steps of detecting a touch trace, determining a plurality of display positions according to the touch trace, and displaying a plurality of function icons at the plurality of display positions.

This application claims the benefit of Taiwan application Serial No. 101130401, filed Aug. 22, 2012, the subject matter of which is incorporated herein by reference.

### BACKGROUND OF THE INVENTION

1. Field of the Invention

The invention relates in general to a touch panel and an associated display method, and more particularly to a touch panel capable of dynamically providing function icons and an associated display method.

2. Description of the Related Art

With developments of the technology, touch functions are prevalent in many portable devices. Meanwhile, an operable area size of touch control is becoming larger to offer users with more convenient operations. For example, electronic books and tablet computers are large-sized (approximately 7.0 to 10.0 inches) portable devices. Although cell phones are usually designed with a smaller size (approximately 3.7 to 4.7 inches), large-sized cell phones are also getting more common.

FIG. 1A shows a schematic diagram of a user operating a conventional touch panel. For illustration purposes, different function icons 1a are represented by circles as examples, and are not limited to the exemplary form of the circles in actual applications.

As shown in FIG. 1A, function icons of the touch panel 1 may be distributed throughout different positions of the touch panel, and so a user is required to hold the touch panel with one hand and perform touch control with the other hand.

That is to say, a large-sized touch panel of a portable device requires both hands of a user to operate. However, a user may not be in a convenient situation to operate the touch panel with both hands at all times as an operation environment of the touch panel differs.

For example, a user may be in an inconvenient situations including being in a moving state, being required to dedicate one hand for other purposes such as holding onto a handle when standing on a public transportation vehicle, holding other objects in one hands while moving, or even having an injured hand. Thus, a user in the above situations cannot control the touch panel using the approach in FIG. 1A.

FIG. 1B shows a schematic diagram of a user holding a touch panel single-handedly. In the situation in FIG. 1B, a user holds the touch panel with right hand. At this point, if function icons are displayed and located at upper-left, upper-right or lower-left sides of the touch panel, the user may not be able to select the function icons at those display positions.

Thus, although large-sized touch panels are getting more prevalent, depending on situations in which the user operates the touch panel 1, a user may not always adapt to the operation approach for controlling the touch panel with both hands at all times. That is to say, the arrangement of the function icons provided by the touch panel 1 may cause operation complications to a user.

### SUMMARY OF THE INVENTION

According to an aspect of the present invention, a display method for a touch panel is provided. The display method includes steps of detecting a touch trace, determining a plurality of display positions according to the touch trace, and displaying a plurality of function icons at the plurality of display positions.

According to another aspect of the present invention, a touch panel is provided. The portable device includes: a display panel; a touch detecting unit, disposed at one side of the touch panel, for detecting a touch trace on the display panel; and a control unit, electrically connected to the display panel and the touch detecting unit, for determining a plurality of display positions according to the touch trace, and controlling the display panel to display a plurality of function icons at the display positions.

According to another aspect of the present invention, a display method for a touch panel is provided. The display method includes steps of: detecting a position of a touch point; and displaying a plurality of function icons according to the position of the touch point and a predetermined arrangement.

According to yet another aspect of the present invention, a touch panel is provided. The portable device includes: a display panel; a touch detecting unit, disposed at one side of the display panel, for detecting a position of a touch point; and a control unit, electrically connected to the display panel and the touch detecting unit, for controlling the display panel to display a plurality of function icons according to the position of the touch point and a predetermined arrangement.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1A (prior art) is a schematic diagram of a user operating a conventional touch panel;

FIG. 1B (prior art) is a schematic diagram of a user holding a touch panel single-handedly;

FIG. 2A is a schematic diagram of a touch panel detecting a touch position of a user thumb when an edge of the touch panel leans against a right palm of the user;

FIG. 2B is a schematic diagram of a touch panel detecting a touch trace of a user when an edge of the touch panel leans against a right palm of the user;

FIG. 3A is a schematic diagram of displaying function icons according to a touch trace;

FIG. 3B is a flowchart of a display method for displaying function icons according to a touch trace according to an embodiment of the present invention;

FIG. 4A is a schematic diagram of displaying function icons at positions of concentric arcs according to an arched touch trace;

FIG. 4B is a schematic diagram of displaying function icons according to concentric arcs of different levels based on the approach in FIG. 4A;

FIG. 4C is a flowchart of displaying function icons according to a touch trace based on FIGS. 4A and 4B according to an embodiment of the present invention;

FIG. 5A is a schematic diagram of displaying function icons along directions of rays of concentric circles according to an arched touch trace;

FIG. 5B is a schematic diagram of displaying function icons along directions of rays of the concentric circles based on the approach in FIG. 5A;

FIG. 5C is a flowchart of displaying function icons at a touch panel according to a position of a touch trace based on FIGS. 5A and 5B according to one embodiment of the present invention;

FIG. 6A is a schematic diagram of a user drawing an arbitrary touch trace using a right thumb when an edge of a touch panel leans against the right thumb of the user;

FIG. 6B is a schematic diagram of a user drawing an arbitrary touch trace using an index finger;

FIG. 7A is a schematic diagram of a touch panel displaying function icons as same-sized icons at a touch trace;

FIG. 7B is a schematic diagram of a touch panel displaying function icons as differently-sized icons at a touch trace;

FIG. 8A is a schematic diagram of a touch panel displaying function icons according to a touch trace arbitrarily drawn by a user and detected by the touch panel;

FIG. 8B is a schematic diagram of a touch panel displaying function icons according to another type of touch trace arbitrarily drawn by a user and detected by the touch panel;

FIG. 8C is a schematic diagram of a touch panel displaying function icons according to another type of touch trace arbitrarily drawn by a user and detected by the touch panel;

FIG. 9 is a flowchart of a display method for displaying function icons based on the approaches in FIGS. 6A, 6B, 7A, 7B, 8A, 8B and 8C;

FIG. 10A is a block diagram of a touch panel according to an embodiment of the present invention;

FIG. 10B is a consolidated flowchart of a display method for displaying function icons according to the foregoing touch traces;

FIG. 11A is a schematic diagram of a predetermined display trace adopted by a touch panel;

FIG. 11B is a schematic diagram of displaying function icons based on FIG. 11A;

FIG. 11C a block diagram of a touch panel according to an embodiment of the present invention;

FIG. 11D a flowchart of a display method for displaying function icons based on the approaches in FIGS. 11A and 11B;

FIG. 12A is a schematic diagram of a user selecting an arbitrary touch point on a touch panel;

FIG. 12B is a schematic diagram of displaying function icons according to the first position of the touch point in FIG. 12A and a predetermined display trace;

FIG. 12C is a schematic diagram of a touch panel displaying function icons based on the approach in FIG. 12B;

FIG. 13A is a schematic diagram of a user selecting an arbitrary touch point on a touch panel;

FIG. 13B is a schematic diagram of displaying function icons according to the second position of the touch point in FIG. 13A and a predetermined display trace; and,

FIG. 13C is a schematic diagram of a touch panel displaying function icons based on the approach in FIG. 13B.

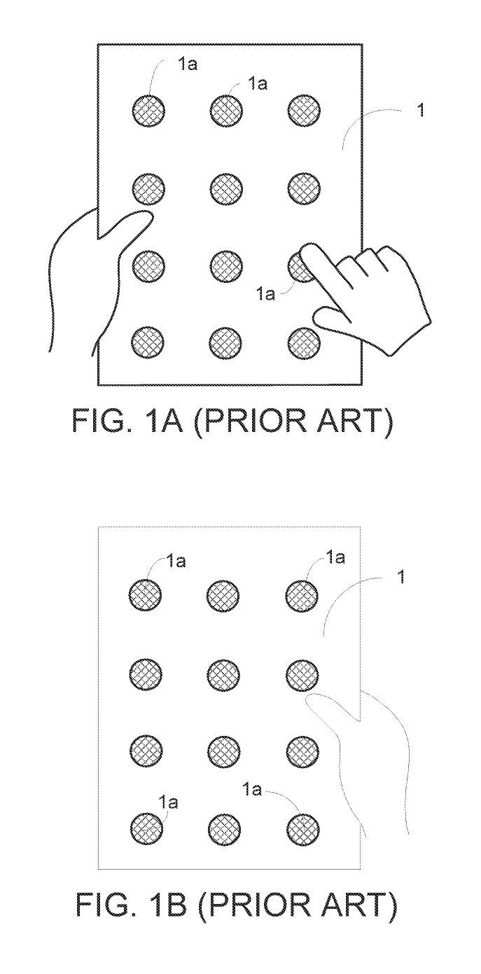

### DETAILED DESCRIPTION OF THE INVENTION

A novel operation concept shall be described with preferred embodiments of the present invention, so as to allow all kinds of portable devices having a touch panel to be single-handedly controlled to enhance the ease of use. It should be noted that, an example of a user holding a portable device with a right hand is given in the following descriptions, and such example is not to be construed as a limitation to the present invention.

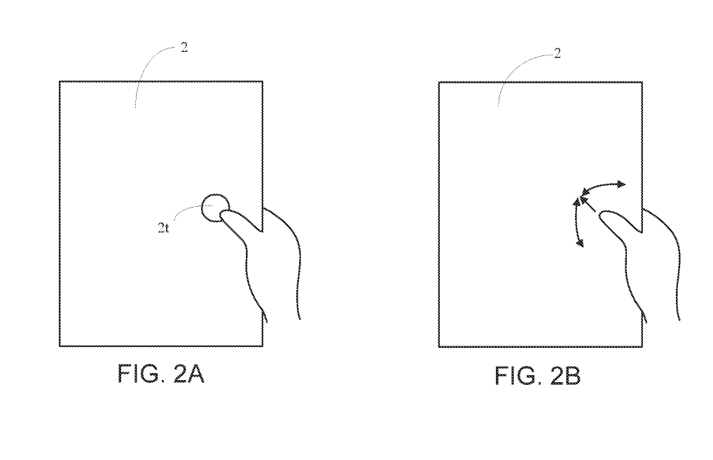

FIG. 2A shows a schematic diagram of a touch panel detecting a touch position of a user thumb when an edge of the touch panel leans against a right palm of the user. In the diagram, it is assumed that the user holds a touch panel 2 with a right hand. Hence, a right edge of the touch panel 2 is clamped between the right thumb and the right index finger of the user. As seen from FIG. 2A, the right thumb of the user forms a contact point 2t on surface of the touch panel 2 when the user holds the touch panel 2.

FIG. 2B shows a schematic diagram of a touch panel detecting a touch trace of a user when an edge of the touch panel leans against a right palm of the user.

As shown by arrows in FIG. 2B, the right thumb of the user is capable of freely moving on the touch panel 2 when the user operates the touch panel 2 single-handedly. Thus, a movement range of the right thumb on the touch panel 2 can be regarded as a readily operable touch control region when the user operates the touch panel 2.

Accordingly, the present invention discloses an operating approach with flexible touch control for a user to operate the touch panel 2.

According to a preferred embodiment of the present invention, the touch panel 2 is capable determining whether a user operates the touch panel 2 in a single-handed operation mode or a two-handed operation mode. After determining which of the operation modes is applied, the touch panel 2 correspondingly provides a function icon display method according to different operation modes.

For example, when a user operates the touch panel 2 with a two-handed operation mode, it is determined that manipulations on the touch panel 2 are relatively easy for the user, and so the function icons can be displayed by an entire display region of the touch panel 2.

In contrast, when it is determined that the user operates the touch panel 2 with a single-handed operation mode, it means that the touch panel 2 is not apt to display function icons in a dispersed manner. Therefore, in order to allow a user manipulate a readily operable touch control region of the touch panel 2, only a partial display region of the touch panel 2 is adopted for displaying function icons.

Through touch behaviors inputted by the user, e.g., tapping, pressing, drawing and sliding, the touch panel 2 may distinguish whether a user wishes to switch a setting of the operation mode. That is, when a user performs an operation behavior (e.g., tapping, pressing, drawing and sliding) for initiating the switching of the operation mode, the touch panel switches its operation mode. For instance, the touch panel is in an operation mode that function icons are displayed at fixed positions at the beginning. After the operation behavior is detected, the touch panel is switched to an operation mode that function icons are flexibly displayed, and vice versa.

For example, when the touch panel 2 detects that a user presses the touch panel 2 for a substantial period of time, the touch panel 2 determines that the user wishes to switch from the two-handed operation mode to the single-handed operation mode. Alternatively, the single-handed operation mode is confirmed and activated according to a predefined touch trace drawn on the touch panel 2. Details of determining the switching of the operation mode may be dependent on different system or applications, and shall be omitted herein.

When the touch panel 2 activates the single-handed operation mode, the touch panel 2 may utilize a smaller display region for displaying function icons. Since the touch panel 2 is capable of changing display region for function icons in response to how the portable device is held by the user, the user is allowed to conveniently perform touch control operations.

Details of how the touch panel 2 detects a single-handed user operation and thus provides an appropriate function icon display region are described below.

According to a preferred embodiment of the present invention, the touch panel 2 first detects a touch trace on the touch panel 2. The touch trace is generated by a user on the touch panel 2 based on the approach in FIG. 2B. In FIG. 2B, the touch panel 2 detects the arched touch trace generated by the user thumb on the touch panel 2. At this point, the arched touch trace may be regarded as a most readily operable range for the user in the entire area of the touch panel 2.

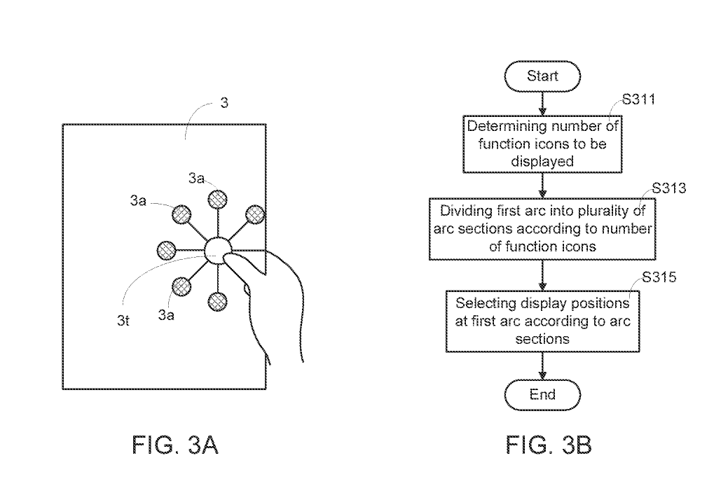

FIG. 3A shows a schematic diagram of displaying function icons according to a touch trace. In FIG. 3A, function icons 3a are displayed in a stellate arrangement around a touch point 3t. A region surrounded by the function icons 3a is substantially equal to the range included by the touch trace indicated by the arrows in FIG. 2B.

Further, the touch trace is considered as a first arc of a circle with a center at a selected position at a side of the touch panel. For example, the selected position at the side of a touch panel 3 is substantially a position at the edge of the touch panel 3 held between a thumb and an index finger of the user. Moreover, the first arc represents the touch trace generated by sliding the thumb on the touch panel 3.

In this preferred embodiment, the touch panel 3 first detects the first arc based on the approach in FIG. 2B, and then determines how to select display positions according to the number of display icons and the first arc. After confirming the display positions, the function icons are then displayed at the display positions.

For example, assume that eight function icons are to be displayed. The first arc is divided into eight arc sections, and eight display positions are selected on the first arc. It should be noted that, the eight arc sections may be equal or unequal in length.

FIG. 3B shows a flowchart of a display method for displaying function icons according to a touch trace based on FIG. 3A.

In step S311, the number of the function icons to be displayed is determined. In step S313, the first arc is divided into multiple arc sections according to the number of the function icons. In step S315, the display positions at the first arc are selected according to the arc sections.

When displaying the function icons 3a, the function icons 3a are dispersed around a center formed by the touch point 3t. Thus, even when the user keeps holding the portable device single-handedly by the right hand, the function icons 3a may still be easily selected through operations by moving the right thumb to implement touch control.

Further, assuming that the user similarly holds the touch panel 3 using the right hand, the touch panel 3 may be held at an upper-right or lower-right part of the touch panel in difference circumstances. At this point, the operating range defined according to the position of the touch point 3t may also change.

Therefore, as illustrated by the above descriptions and the accompanying drawings, the method of providing selectable function icons around the center defined by the touch point of an initial state offers the user enhanced flexibilities when operating the display panel. It should be noted that the above method may also be applied to applications where a user performs touch control using a left hand or other fingers.

Based on the above, the display method for the display panel to display the function icons according to a flexibly defined operating range may be implemented through different approaches. Other approaches for defining the operating range are further described below.

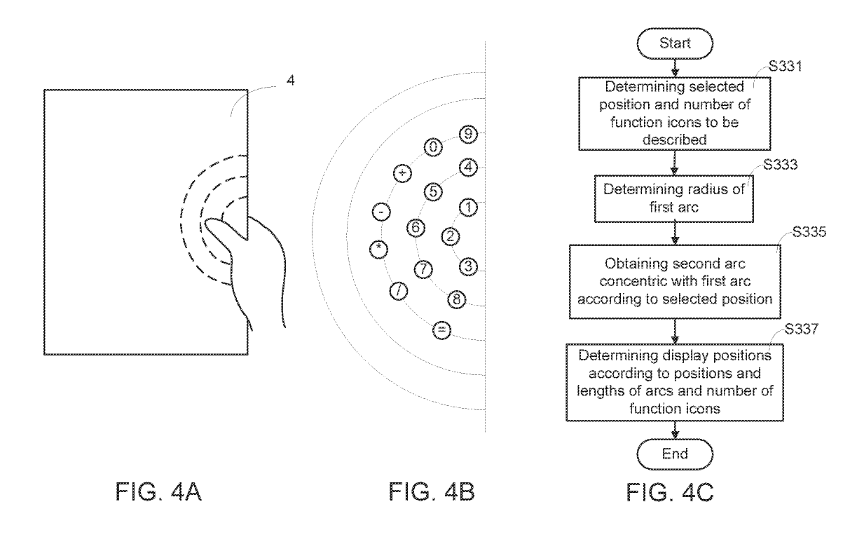

FIG. 4A shows a schematic diagram of displaying function icons at positions of concentric arcs according to an arched touch trace. Similarly, it is assumed that a user draws an arched touch trace on a touch panel 4 using a right thumb based on the approach in FIG. 2B.

The touch panel 4 may then display function icons at predetermined arched traces concentric with the drawn arched touch trace. It should be noted that, although the concentric arched traces are depicted in dotted lines, the touch panel 4 may selectively display the arched traces.

FIG. 4B shows a schematic diagram of displaying function icons according to concentric arcs of different levels based on the approach in FIG. 4A. For illustration purposes, only an actual region displaying the function icons in FIG. 4A is shown in FIG. 4B.

When a user wishes to utilize a calculator function under such mode, the display image shows Arabic numerals and operators. It is also assumed that possible functions icons to be used are arranged and displayed at concentric arched traces of three different levels.

In this preferred embodiment, Arabic numerals 1 to 3 are displayed on the innermost arched trace, Arabic numerals 4 to 8 are displayed on the second innermost concentric arched trace, and Arabic numerals 9 and 0, and the operators are display on the third innermost concentric arced trace.

When the touch panel 4 adopts the display method in FIG. 4B for displaying function icons associated with the calculator function, the user may keep the gesture of holding the portable device with the right hand while performing the calculator function through movements of the right thumb. Therefore, such display method for displaying the function icons further enhances the operation flexibilities of the portable device.

FIG. 4C shows a flowchart of displaying function icons according to a touch trace based on FIGS. 4A and 4B according to an embodiment of the present invention.

In step S331, the selected position and the number of function icons to be displayed are determined. In step S333, a radius of a first arc is determined. In step S335, a second arc concentric with the first arc is obtained according to the selected position. In step S337, the display positions are determined according to the positions and lengths of the first and second arcs and the number of the function icons.

It should be noted that contents of software applications are not limited to the examples disclosed in the description associated with the display method for displaying the function icons. Therefore, for example, functions of the software applications may provide the portable device with operations of making a phone call, utilizing a calculator, browsing an operating interface, selecting a song and selecting a photo. Alternatively, functions icons of the foregoing software applications may be displayed in a similar manner in a main function menu. The above situations are all included as applications of the present invention.

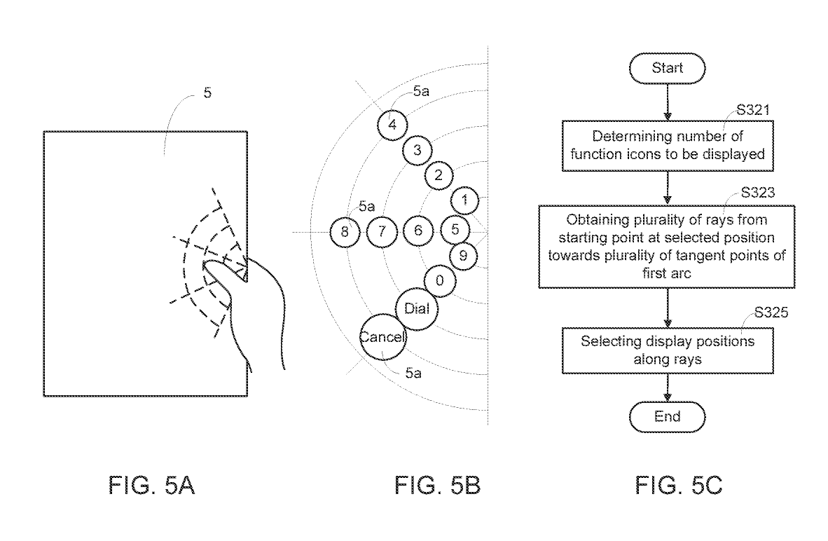

FIGS. 5A and 5B show details of another operation approach for arranging display positions of function icons.

FIG. 5A shows a schematic diagram of displaying function icons along directions of rays of concentric circles according to an arched touch trace. In FIG. 5A, it is assumed that a touch panel 5 displays concentric circles of different levels according to an arc drawn by a user thumb. A difference of FIG. 5A from FIG. 4A is that, the directions of the rays are further defined in FIG. 5A.

FIG. 5B shows a schematic diagram of displaying function icons along directions of rays of the concentric circles based on the approach in FIG. 5A. In FIG. 5B, a phone dialing function is taken as an example, and it is assumed that Arabic numerals are outwardly arranged at intersections of the rays and the concentric arcs.

In a top-down order, three rays in FIG. 4B are defined as a first ray, a second ray and a third ray. Based on the intersections of the three rays and an inner level-four concentric arc, twelve display positions for displaying function icons are defined.

In FIG. 5B, assume that display positions along the first ray display Arabic numerals 1 to 4, display positions along the second ray display Arabic numerals 5 to 8, and display positions along the third ray display Arabic numerals 9 and 0 as well as function keys of “send” and “cancel”. It should be noted that the above definitions of the display positions using intersections of the rays and the parallel arcs are not to be construed as limitations to the present invention.

FIG. 5C shows a flowchart of displaying function icons at a touch panel according to a position of a touch trace based on FIGS. 5A and 5B according to one embodiment of the present invention.

In step S321, the number of the function icons to be displayed is determined. In step S323, a plurality of rays are obtained from a start point at a selected position towards a plurality of tangent points of the first arc. In step S325, the display positions are selected along the rays.

Further, in another application, the touch trace inputted by the right thumb of the user is not limited to an arc, and may be a continuous curve or one touch point.

In the following embodiment, it is assumed that the touch trace drawn by the right thumb of the user is a long and narrow S-shaped trace. Moreover, the user may also draw the touch trace at other positions besides the position near the edge of the touch panel. For example, the user may also draw the touch trace on other region of the touch panel.

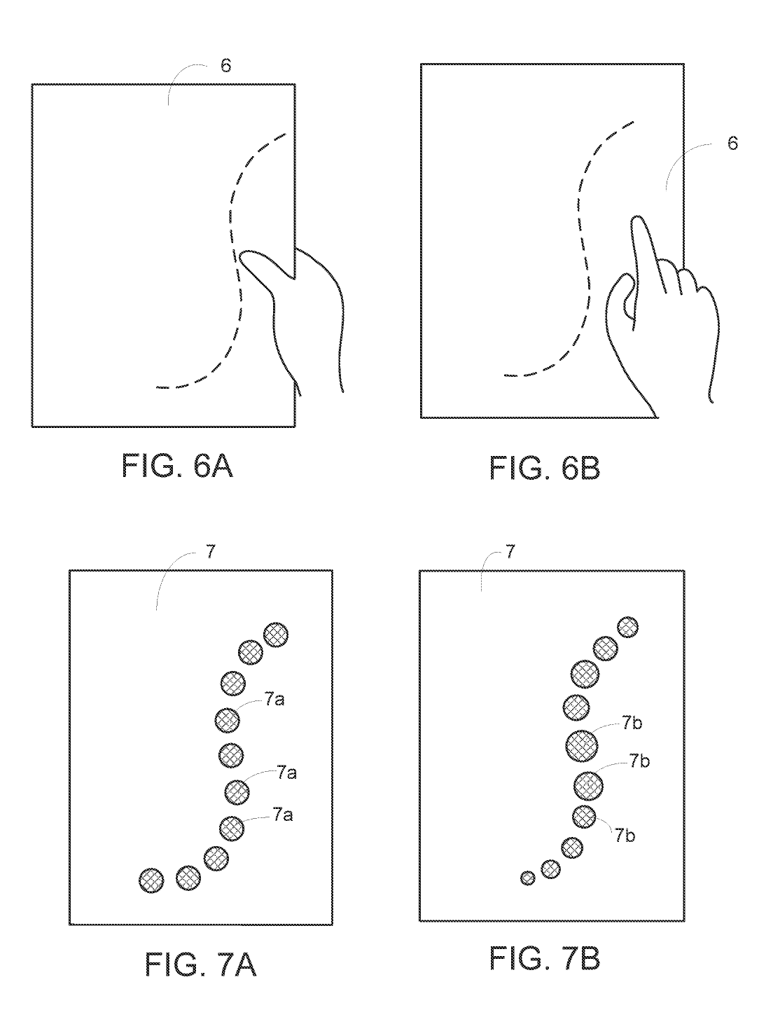

FIG. 6A shows a schematic diagram of a user drawing an arbitrary touch trace using a right thumb when an edge of a touch panel leans against the right thumb of the user. It should be noted that the present invention may also be applied to touch traces having other appearances.

FIG. 6B shows a schematic diagram of a user drawing an arbitrary touch trace using a right index finger. That is to say, apart from a range reachable by the right thumb, the user may also draw an arbitrary touch trace for displaying function icons at an arbitrary position on a touch panel 6 according to personal preferences.

For example, when the user holds an upper part of the touch panel, the touch trace drawn by the user may be closer to the upper part of the touch panel. Alternatively, when the user holds a left side of the touch panel, the touch trace drawn by the user may be closer to the left side of the touch panel, and so forth.

According to a preferred embodiment of the present invention, the display method for displaying function icons may differ when displaying function icons according to an actual touch trace.

FIG. 7A shows a schematic diagram of a touch panel displaying function icons as same-sized icons at a touch trace. In FIG. 7A, it is assumed that a touch panel 7 displays function icons 7a after the user draws the touch trace. Display gaps of the function icons 7a may be equal or different depending on different sections of the touch trace.

FIG. 7B shows a schematic diagram of a touch panel displaying function icons as differently-sized icons at a touch trace. In FIG. 7B, it is assumed that the touch panel 7 displays function icons 7b as differently-sized icons. For example, a currently selected function icon 7b is displayed as a larger icon, and/or the function icons 7b that are closer to a middle part of the touch trace and at positions more readily operable for the user are enlarged.

In addition to the display size of the function icons, gaps between function options in actual display may also be changed through software of the display panel. The modifications with respect to display applications are changes presented by software, and can be easily appreciated and flexibly adjusted by a person having ordinary skill in the art.

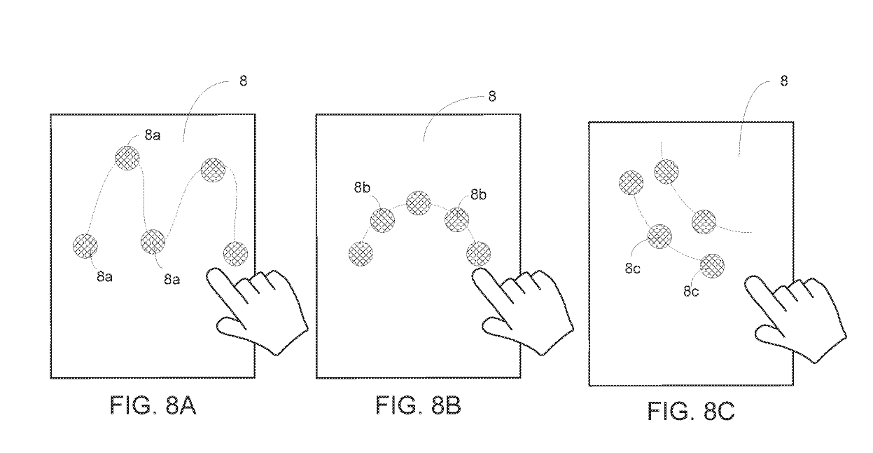

FIG. 8A shows a schematic diagram of a touch panel displaying function icons according to a touch trace arbitrarily drawn by a user and detected by the touch panel. In FIG. 8A, it is assumed that the user draws a zigzag touch trace, and a touch panel 8 displays function icons 8a according to the zigzag touch trace.

FIG. 8B shows a schematic diagram of a touch panel displaying function icons according to another type of touch trace arbitrarily drawn by a user and detected by the touch panel. In FIG. 8B, it is assumed that the user draws a semicircular touch trace, and the touch panel 8 displays function icons 8b according to the semicircular touch trace.

FIG. 8C shows a schematic diagram of a touch panel displaying function icons according to another type of touch trace arbitrarily drawn by a user and detected by the touch panel. In FIG. 8C, it is assumed that the user draws a touch trace formed by two arcs, and the touch panel 8 displays function icons 8b according to such touch trace.

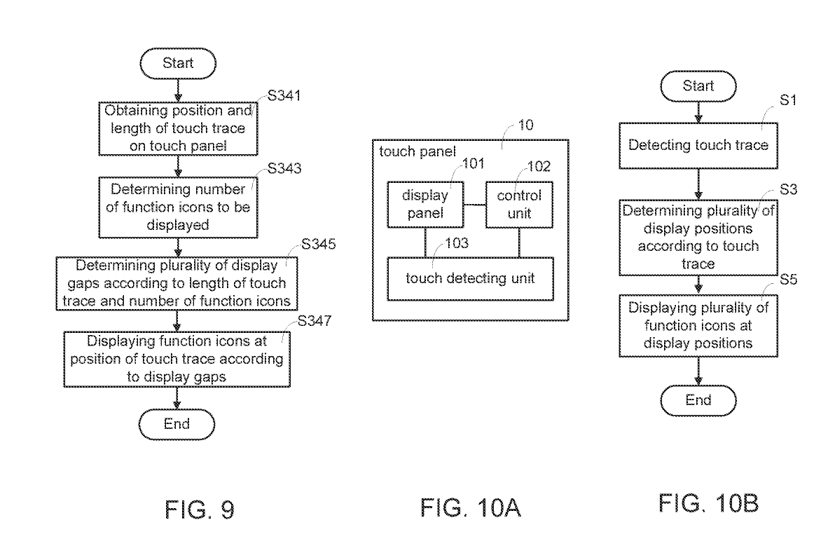

FIG. 9 shows a flowchart of a display method for displaying function icons based on the approaches in FIGS. 6A, 6B, 7A, 7B, 8A, 8B and 8C.

In step S341, a position and a length of the touch trace on the touch panel are obtained. In step S343, the number of the function icons to be displayed is determined. In step S345, a plurality of display gaps are determined according to the length of the touch trace and the number of the function icons. In step S347, the function icons are displayed at the position of the touch trace according to the display gaps.

FIG. 10A shows a block diagram of a touch panel according to an embodiment of the present invention. Referring to FIG. 10A, a touch panel 10 includes a display panel 101, a touch detecting unit 103, and a control unit 102. The touch detecting unit 103 and the control unit 102 are disposed at an inner side of the display panel 101, and all three components are electrically connected to one another.

The touch detecting unit 103 detects a touch trace on the display panel 101. The control unit 102 determines a plurality of display positions according to the touch trace, and controls the display panel 101 to display a plurality of function icons at the display positions.

In other words, the control unit 102 implements the processes shown in FIGS. 3B, 4C, 5C and 9. After determining the display positions of the function icons, the display panel 101 is correspondingly controlled to display the function icons. The touch detecting unit 103 further transmits a touch detection result to the control unit 102 according to the function icons selected by the user for subsequent associated operations.

FIG. 10B shows a consolidated flowchart of a display method for displaying function icons according to the foregoing touch traces. According to the descriptions of the foregoing preferred embodiments, the display method applied to a touch panel includes the following steps.

In step S1, a touch trace is detected. In step S3, a plurality of display positions are determined according to the touch trace. In step S5, a plurality of function icons are displayed at the display positions.

According to another preferred embodiment of the present invention, function icons are displayed according to a predetermined display trace. A user may select an arbitrary point on the display panel, and function icons are then displayed regarding the selected point as a center cooperating with the predetermined display trace.

The predetermined arrangement is display positions for the function icons according to the predetermined display trace and the number of the function icons. For example, the predetermined display trace may be a zigzag trace, an arched trace, a trace in a concentric circular arrangement or a trace in a radiation arrangement etc.

The predetermined display trace may be a display trace configured in advance when the touch panel is manufactured. Further, the portable device may provide a configuration process for allowing the user to configure the predetermined display trace according to personal preferences.

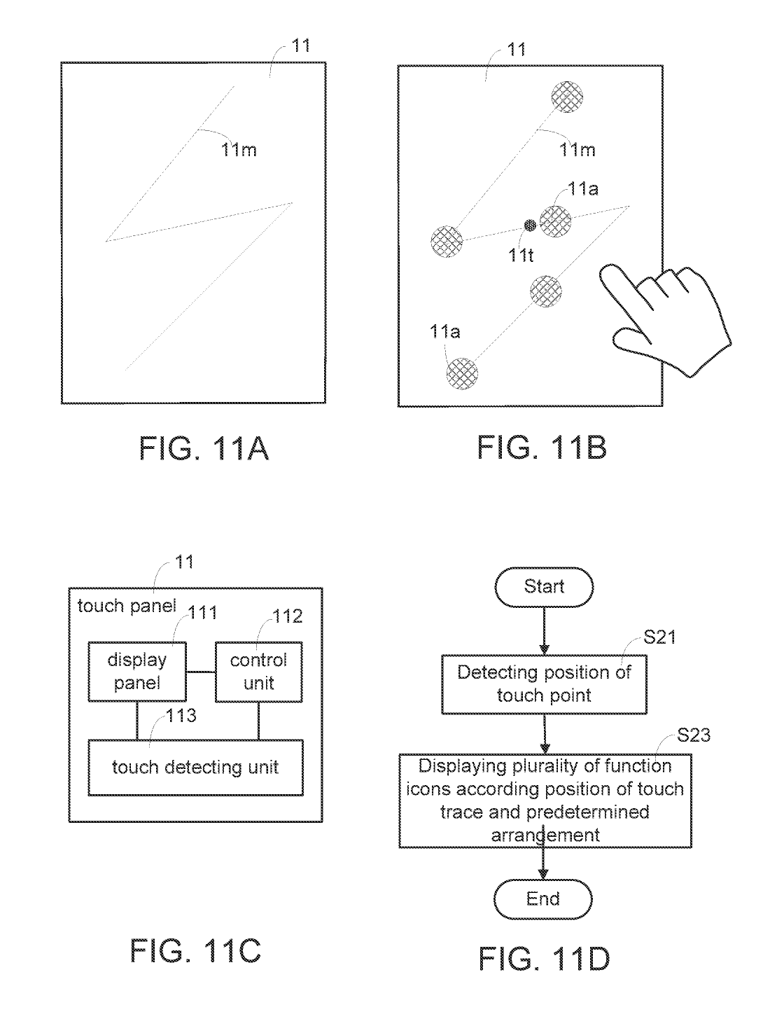

FIG. 11A shows a schematic diagram of a predetermined display trace adopted by a touch panel. In FIG. 11A, it is assumed that the predetermined display trace is a touch trace appearing as a lightening. The predetermined display trace may be a fixed predetermined display trace provided by the touch panel, or may be a predetermined display trace defined through a personalized configuration process by a user.

When the user selects an arbitrary touch point on the touch panel, the touch point is regarded as a center of the predetermined display trace. The touch panel then displays the function icons along the predetermined display trace on the display panel.

FIG. 11B shows a schematic diagram of displaying function icons based on FIG. 11A. In FIG. 11B, display positions defined according to the predetermined display trace for displaying the function icons are illustrated. Similarly, in practice, the approach for displaying the function icons may also differ as applications, and the number of the function icons to be displayed becomes different.

For example, when a large number of function icons are to be displayed, the display gaps may be changed. Display gaps having different lengths may be designed between different function icons, or different function icons may be same-sized or different-sized. Alternatively, the user may also define function icons frequently used in the single-handed operation mode, and select only the more frequently used function icons for display.

The above approaches, which can be flexibly adjusted when implementing system software planning for the portable device, are quite diversified and shall not be further discussed.

That is to say, the touch panel provides a predetermined display trace, and the user selects the desired touch point. As the position of the touch point changes, the display trace regards the touch point as a center for display is changed, so as the display positions of the function icons.

FIG. 11C shows a block diagram of a touch panel according to an embodiment of the present invention. A touch panel 11 includes a display panel 111, a touch detecting unit 113 and a control unit 112. The touch detecting unit 113 and the control unit 112 are disposed at an inner side of the display panel 111, and the three components are electrically connected to one another.

The touch detecting unit 113 first detects a position of a touch point. The control unit 112 controls the display panel 111 to display a plurality of function icons according to the position of the touch point and a predetermined arrangement (predetermined display trace).

FIG. 11D shows a flowchart of dynamically detecting a touch point position and displaying function icons according to a predetermined display trace according to a preferred embodiment of the present invention. The method includes the following steps.

In step S21, a position of a touch point is detected. In step S23, a plurality of function icons are displayed according to the position of the touch point and a predetermined arrangement.

According to a preferred embodiment of the present invention, a method for operating a touch panel single-handedly is provided for a user. The method can be further applied to operation circumstances of various touch panels, and is not limited to applications of single-handed operations.

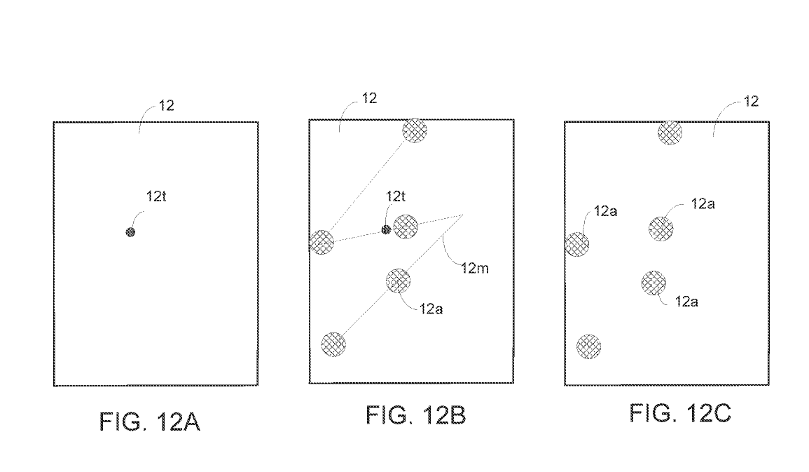

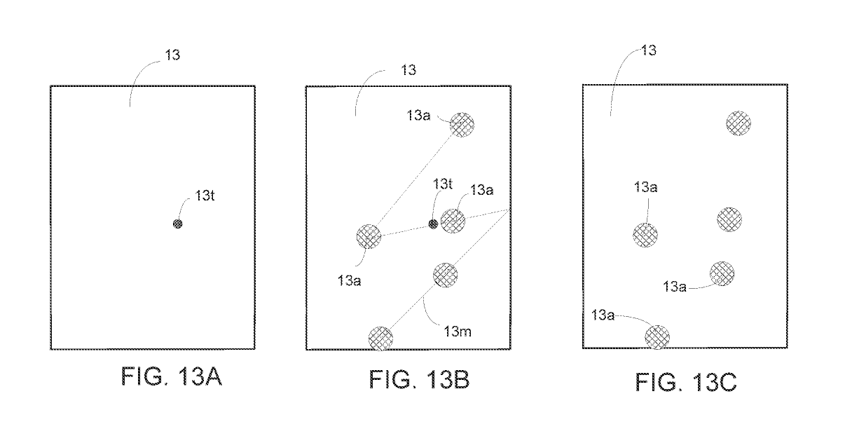

To further explain the concept of the present invention, approaches for displaying function icons at different positions of a display panel are described below. FIGS. 12A to 12C and FIGS. 13A to 13D indicate how function icons are displayed when position of the touch point changes.

FIG. 12A shows a schematic diagram of a user selecting an arbitrary touch point on a touch panel. In FIG. 12A, it is assumed that the user selects a touch point 12t at a first position of a touch panel 12.

FIG. 12B shows a schematic diagram of displaying function icons according to the first position of the touch point in FIG. 12A and a predetermined display trace.

In FIG. 12B, the touch panel 12 regards the first position selected by the user as a center of a predetermined display trace 12m. After determining the display trace 12m according to the position of the touch point 12t, how to display function icons 12a are then determined by use of the predetermined display trace.

FIG. 12C shows a schematic diagram of a touch panel displaying function icons based on the approach in FIG. 12B. In FIG. 12C, function icons are displayed on the touch panel based on the approach in FIG. 12B.

FIG. 13A shows a schematic diagram of a user selecting an arbitrary touch point on a touch panel. In FIG. 13A, it is assumed that the user selects a touch point 13t at a second position of a touch panel 12.

FIG. 13B shows a schematic diagram of displaying function icons according to the second position of the touch point in FIG. 13A and a predetermined display trace. Display positions of function icons 13a are defined by an approach similar to that in FIG. 11C, with however the second position being regarded as a center of a predetermined display trace 13m.

Compared to the first position, the second position is located more to the right side of the display panel 13, and so the predetermined display trace 13m on the display panel 13 is also closer to the right side of the display panel 13.

FIG. 13C shows a schematic diagram of a touch panel displaying function icons based on the approach in FIG. 13B. In FIG. 13C, function icons are displayed on the touch panel based on the approach in FIG. 13B.

It is concluded by comparing FIGS. 12C and 13C, the actual display positions of the function icons are adjusted according the change in the position of the touch point selected by the user.

Comparing the first position in FIG. 12A with the second position in FIG. 13A, it is observed that the position of the second position is closer to the right side of the display panel. Again comparing FIGS. 12C and 13C, with respect to overall display of the function icons, it is also observed that the function icons in FIG. 13C are closer to the right side of the touch panel compared to the function icons in FIG. 12C.

Based on whether detecting a touch trace or detecting a position of a touch point cooperating with a predetermined display trace, the display method of the present invention can be implemented by an on-screen display (OSD). In practice, the function icons displayed by the display method may correspond to a plurality of software applications or correspond to a plurality of parameter settings of the same software application.

When the function icons correspond to a plurality of software applications, function icons corresponding a categorized function options are provided in a main menu, e.g., various games in a game menu. When the function icons correspond to a plurality of parameter settings, for example, function icons for playback, fast-forward and volume adjustment are provided for a video-audio playback application, or numeric buttons provided for a calculator function.

The present invention is applicable to portable devices such as smart phones, mobile navigation devices, video-audio entertainment devices and tablet computers etc. In addition to allowing a user to readily operate the portable device single-handedly, the method of the present invention further allows the user to configure a personalized operating interface according to personal preferences.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display method for a touch panel, comprising steps of:
detecting a touch trace;
determining a plurality of display positions according to the touch trace; and
displaying a plurality of function icons at the plurality of display positions.

2. The display method according to claim 1, wherein the touch trace is a first arc drawn according to a center at a selected position at a side of the touch panel.

3. The display method according to claim 2, wherein the step of determining the plurality of display positions according to the touch trace comprises steps of:
determining a number of the function icons to be displayed;
dividing the first arc into a plurality of arc sections according to the number of the function icons; and
selecting the plurality of display positions at the first arc according to the plurality of arc sections.

4. The display method according to claim 2, wherein the step of determining the plurality of display positions according to the touch trace comprises steps of:
determining a number of the function icons to be displayed;
obtaining a plurality of rays from a start point at the selected position towards a plurality of tangent points of the first arc; and
selecting the plurality of display positions along the plurality of rays.

5. The display method according to claim 2, wherein the step of determining the plurality of display positions according to the touch trace comprises steps of:
determining the selected position and determining a number of the function icons to be displayed;
determining a radius of the first arc;
obtaining a second arc of a circle concentric with the first arc according to the selected position; and
determining the plurality of display positions according to positions and lengths of the first and second arcs and the number of the function icons.

6. The display method according to claim 1, wherein the step of determining the plurality of display positions according to the touch trace comprises steps of:
obtaining a position and a length of the touch trace on the touch panel;
determining a number of the function icons to be displayed;
determining a plurality of display gaps according to the length of the touch trace and the number of the function icons; and
displaying the function icons along the position of the touch trace according to the display gaps.

7. The display method according to claim 6, wherein lengths of the display gaps are equal, or different according to different sections of the touch trace.

8. The display method according to claim 1, wherein the function icons correspond to a plurality of software applications or a plurality of parameter settings of a software application.

9. A touch panel, comprising:
a display panel;
a touch detecting unit, disposed at one side of the display panel, for detecting a touch trace on the display panel; and
a control unit, electrically connected to the display panel and the touch detecting unit, for determining a plurality of display positions according to the touch trace and controlling the display panel to display a plurality of function icons at the display positions.

10. The touch panel according to claim 9, wherein the control unit determines a number of the function icons to be displayed, divides the touch trace into a plurality of arc sections according to the number of the function icons, and selects the plurality of display positions at the touch trace according to the plurality of arc sections.

11. The touch panel according to claim 9, wherein the control unit determines a number of the function icons to be displayed, obtains a plurality of rays from a start point at a selected position towards a plurality of tangent points of the touch trace, and selects the plurality of display positions along the plurality of rays.

12. The touch panel according to claim 9, wherein the control unit determines a selected position and a number of the function icons to be displayed, obtains a second arc of a circle concentric with the touch trace, and determines the plurality of display positions according to positions and lengths of the touch trace and second arc, and the number of the function icons.

13. The touch panel according to claim 9, wherein the control unit obtains a position and a length of the touch trace on the touch panel, determines a number of the function icons to be displayed, determines a plurality of display gaps according to the length of the touch trace and the number of the function icons, and controls the display panel to display the function icons at the position of the touch trace according to the display gaps.

14. A display method for a touch panel, comprising steps of:
detecting a position of a touch point; and
displaying a plurality of function icons according to the position of the touch point and a predetermined arrangement.

15. The display method according to claim 14, wherein the predetermined arrangement is display positions of the plurality of function icons determined according to a predetermined display trace and a number of the function icons.

16. The display method according to claim 15, wherein the predetermined display trace is obtained according to a user configuration, and is a zigzag trace, an arched trace, a trace of concentric circles, or a trace of radiation rays.

17. The display method according to claim 14, wherein the plurality of function icons correspond to a plurality of software applications or a plurality of parameter settings of a software application.

18. A touch panel, comprising:
a display panel;
a touch detecting unit, disposed at one side of the display panel, for detecting a position of a touch point; and
a control unit, electrically connected to the display panel and the touch detecting unit, for controlling the display panel to display a plurality of function icons according to the position of the touch point and a predetermined arrangement.

19. The touch panel according to claim 18, wherein the predetermined arrangement is display positions of the plurality of function icons determined according to a predetermined display trace and a number of the function icons.
